(19) United States
(12) Patent Application Publication
(10) Pub. No.: US 2003/0146982 A1
(43) Pub. Date: Aug. 7, 2003

(54) Special color pigments for calibrating video cameras

(76) Inventor: John R. Tindall, Oak Park, CA (US)

Correspondence Address: STETINA BRUNDA GARRED & BRUCKER, 75 ENTERPRISE, SUITE 250, ALISO VIEJO, CA, 92656, US

(21) Appl. No.: 10/061,596

(22) Filed: Feb. 1, 2002

(51) Int. Cl. H04N 17/00

(52) U.S. Cl. 348/223.1; 348/182

(57) ABSTRACT

A system and method for calibrating the color balance of a video camera according to a non-standard photographic color temperature. The systems and methods incorporate a plurality of pigments, namely subtractive primary colors (yellow, cyan, magenta), that each may be utilized as a reference to adjust the color balance of a video camera. Each respective pigment is designed to replace the color white or gray as a reference to adjust the color balance so that the camera can capture the natural color of a light source according to a non-standard photographic color temperature (i.e., white).

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The color calibration of video cameras is known in the art. In this respect, video cameras typically include a color balance feature which enables the camera to adjust to the particular lighting of a given scene to be recorded. However, because each video camera system interprets or captures color differently, color balance, a reference from which other colors are determined from another color, typically white, must be established or predetermined prior to shooting a given scene.

To achieve that end, video cameras typically are calibrated prior to recording a given scene by focusing on a white subject, which is typically a clean white surface, and adjusting the color balance of the camera to make that subject appear white in the final video image. In this respect, most cameras typically include an auto-white color balance setting which causes the camera to set the relative gains of the sub-color component amplifiers, namely, red, green and blue. Such color balance feature is well-known in the art and is accomplished by a variety of electronics and software that are commercially available and used extensively in the video industry.

Despite advances made in color balance, and the necessity for establishing color balance prior to recording a particular scene, substantial deficiencies still exist with respect to calibrating video cameras, particularly with respect to a white standard. As is well-known, color balance is limited insofar as the same has a tendency to take natural color out of a video image to the extent such image is recorded using a light source that is not a standard photographic color temperature, such as a candle. Such drawbacks can likewise occur when recording video in very strong sunlight insofar as such sunlight has a potential to overload camera control electronics utilized in calibrating the right color balance setting.

In light of such shortcomings, techniques have been developed in the art to provide the videographer with the ability to record a scene according to a desired light source calibration to thus correct for variations in the color temperature of a particular light source. According to one well-recognized technique, one or more cameras are calibrated according to a standard white material or color by using standard studio light. Thereafter, a color correction filter is applied to all of the lighting units utilized in the scene. By applying such filters, the correct light is cast upon the scene and can be recorded accordingly. Such practice, however, is known to be quite costly and time-consuming. Another frequently deployed practice involves adjusting the aperture of the camera such that a white subject is ultimately captured on film that corresponds to a particular standardized exposure, such as a normal “gray card” exposure (i.e., any of a variety of standardized card references for establishing color calibration, which are well-known and readily available to any one skilled in the art). Such practice, however, is also problematic and exceptionally time consuming. Moreover, such practice involves tremendous skill in attaining a desired exposure which, if incorrect, could ruin the videographer's ability to capture the desired light on video.

Such problems are compounded even further to the extent other factors affecting light are involved of the shooting of a particular scene. For example, substantial difficulties arise in trying to calibrate cameras utilized to shoot a scene utilizing mixed lighting (i.e., when lighting consists of different color temperatures), which can arise when a given scene is shot utilizing a combination of daylight, flourescent or tungsten-filament light. Complications also arise to the extent a given scene is sought to be recorded utilizing special lighting and exposure control, such as can occur when scenes are intentionally over or under exposed, or if color lighting and other special effects are utilized. Compounding such issues further is the fact that multiple cameras are typically utilized which often shoot at different angles of the same scene. As a consequence, to the extent color calibration is not matched perfectly, (i.e., to a reliable, reproducible reference) color and brightness differences between cameras shooting the same scene can become quite noticeable and again adversely affect the recorded scene.

Accordingly, there is a substantial need in the art for a system and method for calibrating video cameras that can easily and quickly be utilized to calibrate the color balance of a video camera according to a non-standard photographic color temperature to thus enable a videographer to capture a desired color. There is further a need in the art for such a system and method that easily and readily replaces prior techniques to capture a desired non-standard color temperature in a manner that is not labor intensive nor costly in deployment. Still further there is a need for such a system and method that can be readily utilized using existing color balance functions already incorporated as part of virtually all video and studio cameras currently in use.

### BRIEF SUMMARY OF THE INVENTION

The present invention specifically addresses and alleviates the above- identified deficiencies in the art. In this regard, the present invention is directed to a system and method for adjusting the color balance of a video camera to enable a videographer to capture desired variations in color temperature by readily adjusting the color balance of the camera according to a non-standard, non-white color reference. According to a preferred embodiment, the system comprises a collection of subtractive primary colors (cyan, magenta, yellow) pigments, wherein each respective pigment is utilized as a reference to adjust the color balance of a camera. Each specific pigment correspondingly causes the color balance of the camera to adjust in a specific manner to capture a desired non-standard photographic color temperature effect and are designed to replicate certain desired light sources/photographic color temperatures. White balancing a camera on the special pigments has the same effect as using a standard white subject and employing a camera or light filter of the complementary color. In fact, often times the pigments that are chosen are exact complements of existing photographic and lighting filters.

For example, by utilizing a pigment having a color corresponding to 12 magenta 29 cyan, when utilized as a color balance reference, enables a given scene to be recorded with the video camera that will capture the natural color of candlelight, which would not otherwise be captured simply using a white subject for adjusting the color balance. The pigments of the present invention, can be utilized with virtually all conventional cameras having color balance functions, such as any video camera with automatic white balance function.

The use of the system of the present invention may be accomplished via conventional techniques. However, as opposed to adjusting color balance via conventional white reference, any of the pigments of the present invention will be substituted therefor as may be desired by the videographer. Once the color balance has been adjusted utilizing a particular pigment as a reference, the camera may be utilized to record a given scene. Advantageously, no manipulation is required regarding color adjustments to lighting units used about a recording of a given scene. As a result, the videographer is thus easily and readily able to capture a desired lighting effect on film without undue experimentation and/or increased labor and cost.

### BRIEF DESCRIPTION OF THE DRAWINGS

These, as well as other features of the present invention, will become more apparent upon reference to the drawings wherein:

FIG. 1 is a top view of an individual utilizing a reference to adjust the color balance of a camera.

FIG. 2 is a top view of a reference being utilized to calibrate the color balance of a camera wherein the lighting about such reference consists of different color temperatures.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

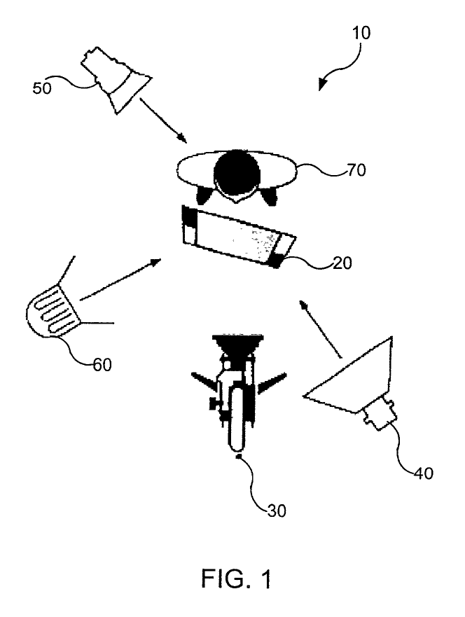

Referring now to the figures, and initially to FIG. 1, there is shown a conventional method and arrangement 10 by which a reference 20 is utilized to calibrate the color balance of a camera 30 to thus enable the camera 30 to correct for variations in the color temperature of a light source, as provided by surrounding light sources 40, 50, 60. With respect to the latter, the same typically comprise a wide-beam lighting unit 40, back light 50, and cross-light 60. Preferably, the reference 20, which typically comprises a card placed near the main subject of the scene 70, is positioned at the actual depth where the scene is recorded. From such point, the color balance of the camera 30 focuses upon such reference 20, which is typically white or gray, and the color balance of the camera 30 adjusted, typically via an automated process by which camera control units and electronics within the camera automatically set the relative gains of the sub-color component amplifiers, namely, red, green and blue amplifiers, which process the coloring of the film footage.

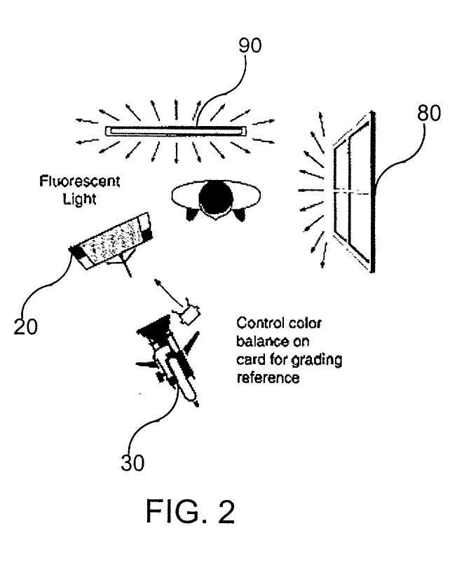

Such arrangement of the foregoing components are well-known in the art and utilized extensively in videography. Additionally, such arrangement may be varied as may be desired to capture a particular lighting effect or exposure. For example, as depicted in FIG. 2, there is shown an arrangement by which the color balance of the camera 30 may be set using a reference 20 given a scene having mixed lighting, that is, lighting comprised of different color temperatures, such as a fluorescent or tungsten light 90 coupled with daylight 80. Typically, under such circumstances, the color balance must be set according to the color temperature which is visually most dominant or by taking an average of such color temperatures.

The foregoing techniques, although well known, typically are universal in an application of a white or gray subject as the reference 20 from which the color balance of the camera 30 is calibrated. The present invention, in contrast, utilizes a plurality of pre-selected pigments consisting of subtractive colors having an angstrom range within the visible spectrum from 400 to 700 nm as the reference 20 from which the color balance of the camera 30 is set. In this respect, each respective one of the pigments of the present invention is selectively designed to be substituted for the reference color to thus enable the color calibration of the camera to conform to a non-standard photographic color temperature. Specifically, each pigment color reference selectively enables the camera, via the color balance functions already incorporated therein, to adjust the color balance to thus enable a given scene to be recorded according to such non-standard photographic color temperature to thus capture the natural color of the non-standard photographic color temperature directly, and without the use of color correction filters or other techniques known in the art that attempt to capture such natural color. Therefore, a person familiar with the actions of established camera and lighting filters can use such pigments (i.e., “filter cards”) to reproduce those effects by using the electronics of the video cameras. Such pigments are listed in Table 1 herebelow which identifies the color balance filter; yellow, magenta, and cyan settings, shift in color temperature, and what corresponding non-standard photographic color temperature is generated by use of such pigment as the reference by which the color balance of the camera is set:

TABLE 1

| | | | | Shift in Color | Effect on image |
|---|---|---|---|---|---|
| Color Balance | | | | temperature | when used as |
| filter | Yellow | Magenta | Cyan | ° k. | effect filter |
| C.B. ⅛ | 4 | 1 | | −200° k. | Slight |
| | | | | | “Warming” |
| Complementary | | 2 | 2 | | Create or |
| Pigment | | | | | maintain same |
| | | | | | effect |
| C.B. ¼ | 8 | 3 | | −400° k. | “Warming” |
| | | | | | Effect |
| Complementary | | 5 | 8 | | Create or |
| Pigment | | | | | maintain same |
| | | | | | effect |
| C.B. ½ | 14 | 6 | | −600° k. | “Early |
| | | | | | Morning” |
| Complementary | | 9 | 14 | | Create or |
| Pigment | | | | | maintain same |
| | | | | | effect |
| C.B. 1 | 22 | 10 | | −1100° k. | “Late |
| | | | | | Afternoon” |
| Complementary | | 11 | 22 | | Create |
| Pigment | | | | | maintain same |
| | | | | | effect |
| C.B. 2 | 30 | 18 | | −1600° k. | “Candlelight” |
| Complementary | | 12 | 29 | | Create or |
| Pigment | | | | | maintain same |
| | | | | | effect |
| C.B. 3 | 45 | 27 | | −2300° k. | “Sunset” or |
| | | | | | “Firelight” |
| Complementary | | 20 | 46 | | Create or |
| Pigment | | | | | maintain same |
| | | | | | effect |

In addition to “color correction” effects, the pigments can be used to duplicate most color effect filters. A partial list of filters and their uses follows in Table 2 below.

TABLE 2

| | | | | Effect on image |
|---|---|---|---|---|
| Color Effect | | | | when used as |
| filter | Yellow | Magenta | Cyan | effect filter |
| Sunset | 83 | 57 | | Deep “Sunset” |
| | | | | Effect |
| Complementary | | 51 | 86 | Create same |
| Pigment | | | | effect |
| Sepia 1 | 20 | 12 | | “Old Time |
| | | | | Photograph” |
| Complementary | | 8 | 19 | Create same |
| Pigment | | | | effect |
| Sepia 2 | 44 | 27 | | Stronger “Old |
| | | | | Time |
| | | | | Photograph” |
| Complementary | | 18 | 46 | Create same |
| Pigment | | | | effect |
| Tiffen 812 | 7 | 6 | | Pleasing warm |
| | | | | tones |
| Complementary | | 1 | 8 | Create same |
| Pigment | | | | effect |
| Tiffen “Warm | 9 | 7 | | Pleasing warm |
| fx” | | | | tones |
| Complementary | | 1 | 8 | Create same |
| Pigment | | | | effect |
| Tiffen Antique | 27 | 10 | | Pleasing warm |
| Suade | | | | tones with |
| | | | | slight sepia |
| | | | | look |
| Complementary | | 18 | 27 | Create same |
| Pigment | | | | effect |

It is contemplated that the pigments of the present invention can be utilized as calibration references (i.e., formed as cards or colored surfaces) for virtually all types of video cameras in use. Among those cameras particularly well suited for use in the practice of the invention include all video cameras with automatic white balance features. It is further contemplated that such pigment references can be utilized as per conventional white references for use in recording scenes involving mixed lighting or graded darker or lighter. Other applications will be readily apparent to those skilled in the art with respect to colored lighting or for use with special effects. Additional applications will further be readily apparent to those skilled in the art.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

1. A system for calibrating the color balance of a camera comprising a pigmented card sized and configured for use as a reference to adjust the color balance of said camera, said pigment comprising the color having a non-standard photographic color temperature.

2. The system of claim 1 wherein said pigment is selected from the group consisting of subtractive colors having an angstrom range within the visible spectrum from 400 to 700 nm.

3. A method of calibrating the color balance of a camera comprising the steps:
a) providing a video camera and a pigmented surface, said pigmented surface having a color corresponding to a non-standard photographic color temperature; and
b) calibrating said color balance of said camera utilizing said pigmented surface as said reference for said color balance.

4. The method of claim 3 wherein in step (a), said pigment of said surface is selected from the group consisting of subtractive colors having an angstrom range within the visible spectrum from 400 to 700 nm.
